(19) United States
(12) Patent Application Publication
(10) Pub. No.: US 2016/0188808 A1
(43) Pub. Date: Jun. 30, 2016

(54) SYSTEM AND METHODS FOR AUTOMATED HEALTHCARE PATIENT RECORD SEARCH, EXTRACTION, AND CREATION

(71) Applicant: The Quantum Group Inc., West Plam Beach, FL (US)

(72) Inventors: Pedro MARTINEZ, Boca Raton, FL (US); Noel GUILLAMA, Wellington, FL (US)

(21) Appl. No.: 14/953,964

(22) Filed: Nov. 30, 2015

Related U.S. Application Data
(63) Continuation of application No. 12/418,685, filed on Apr. 6, 2009, now abandoned.
(60) Provisional application No. 61/043,319, filed on Apr. 8, 2008.

(51) Int. Cl. G06F 19/00

(52) U.S. Cl. CPC G06F 19/322

(57) ABSTRACT

A system for processing patient information is provided. The system includes a search engine for identifying and retrieving patient-specific data from one or more of the databases. Additionally; and a system administrator for coordinating a plurality of database searches preformed by the search engine and for generating a patient-specific uniform health record (UHR) comprising data retrieved by the search engine.

### CROSS-REFERENCE TO RELATED APPLICATIONS

This application is a continuation of U.S. Non-Provisional Application No. 12/418,685, which was filed on Apr. 6, 2009 entitled “SYSTEM AND METHODS FOR AUTOMATED HEALTHCARE PATIENT RECORD SEARCH, EXTRACTION, AND CREATION”, which claims the benefit of U.S. Provisional Patent Application No. 61/043,319, which was filed Apr. 8, 2008, and which is incorporated herein in its entirety.

### FIELD OF THE INVENTION

The present invention is related to the field of data processing, and more particularly, to techniques for efficiently creating and handling medical-related records.

### BACKGROUND OF THE INVENTION

Modern medical care generally involves a complex set of relationships involving patients, their physicians, hospitals, medical insurance providers, and many other healthcare professionals and providers. Conventionally, each of the various actors participating in providing healthcare to an individual patient, including the patient himself, maintain separate records pertaining to medical procedures performed, the results of those procedures, and the compensation paid by the patient or insurer for different medical services.

As a result, even as data processing technology becomes increasingly more sophisticated, these efficiencies are often not translated into efficiencies within the healthcare arena. This is largely because the many databases in which are stored the medical records pertaining to an individual patient are each typically maintained separately, in an uncoordinated fashion. Moreover, it is frequently the case that data in a database maintained by one healthcare provider is not accessible to other healthcare providers, or perhaps even the patient himself.

As a result, many healthcare providers involved in providing care for the same patient do not have available to them a common set of patient data that other providers and professionals caring for the same patient have; each healthcare professional is thus likely to see only part of the overall complex arrangements involved in providing care to an individual patient. This can lead to considerable inefficiencies, as for example, when the lack of coordinated data sharing results in multiple, sometimes unnecessary, procedures being performed on a patient. It can also lead to delays in processing other relevant data, such as financial and insurance records, all of which further reduces efficiency in providing healthcare to a patient.

### SUMMARY OF THE INVENTION

The present invention is directed to systems and methods for generating and processing healthcare data. One aspect of the invention is the coordinated creation of a Universal Health Record (UHR) for an individual patient based upon electronic searches of multiple public and private patient record databases. The invention provides the capabilities for effecting a single, multidimensional search of disparate databases, and for populating patient information records with data obtained from a wide variety of non-uniform databases of different data types. The invention also permits such records to be updated through frequent or even continuous synchronization of separate changes made in records pertaining to the same patient but maintained in disparate databases.

One embodiment of the invention is a system for processing patient information. The system can include a search engine for identifying and retrieving patient-specific data from one or more of the databases. The system further can include a system administrator for coordinating a plurality of database searches performed by the search engine, and for generating a patient specific uniform health record (UHR) comprising data retrieved by the search engine.

Another embodiment of the invention is a computer-implemented method for processing patient information. The method can include coordinating a plurality of database searches of two or more databases for data corresponding to a particular patient. Additionally, the method can include retrieving from one or more of the databases data corresponding to the patient. The method can further include generating a patient-specific uniform health record (UHR) comprising the retrieved data.

Still another embodiment of the invention is a computer-readable medium in which is embedded computer-readable code, which when loaded on a computer causes the computer to perform the following steps: coordinating a plurality of database searches of two or more databases for data corresponding to a particular patient; retrieving from one or more of the databases data corresponding to the patient; and, generating a patient-specific uniform health record (UHR) comprising the retrieved data.

### BRIEF DESCRIPTION OF THE DRAWINGS

There are shown in the drawings, embodiments which are presently preferred. It is expressly noted, however, that the invention is not limited to the precise arrangements and instrumentalities shown in the drawings.

FIG. 1 is a schematic view of an exemplary network environment in which a system for processing patient information, according to one embodiment of the invention, can be utilized.

FIG. 2 is a more detailed schematic view of the system shown in FIG. 1.

FIG. 3 is a schematic view of certain operative features of the system illustrated in FIGS. 1 and 2.

FIG. 4 is a flowchart of exemplary steps in a method for processing patient information, according another embodiment of the invention.

FIG. 5 is a flowchart of exemplary steps in a method for updating patient information, according to yet another embodiment of the invention

### DETAILED DESCRIPTION

The present invention is directed to systems and methods for more efficiently generating and processing health care data. The various embodiments of the invention include systems and methods for creating, in a coordinated fashion, patient-specific Universal Health Records (UHRs). The creation can be effected through electronic searches of multiple public and private patient record databases. More particularly, a single, multidimensional search of disparate databases can be performed, and, based upon the search, patient information records can be automatically populated with data obtained from a wide variety of non-uniform databases of different data types. Such records can be frequently, or even continuously, maintained through the synchronized searching of separate records that is another aspect of the invention.

In particular embodiments, a patient, the patient's doctors, hospitals, insurance carriers, and any other authorized agent participating in the patient's healthcare can obtain access to the same set of patient information. For example, each agent can access, under any proper privacy conditions, the same set of physician's notes, medical images (e.g., x-rays and MRIs), insurance information, and other patient-specific information. Access to this common, complete set of data can provide numerous benefits, such as preventing the unnecessary repetition of medical procedures. More fundamentally, it can enhance efficiencies in handling disparate and dispersed information needed to effectively and efficiently administer healthcare to the patient.

FIG. I is a schematic view of an exemplary network environment 100 in which a system 102 for processing patient information, according to one embodiment of the invention, can be utilized. The network environment 100 illustratively includes, in addition to the system 102, a plurality of databases, defining primary caregiver databases, PCGDBᵢ, i=1, . . . , N, (collectively 104). The databases PCGDBᵢ, i=1, . . . , N, include databases maintained, for example, by physicians and hospitals. Each such database PCGDBᵢ comprises a set of data Dᵢ, i=1, . . . , N, such as a physician's notes and various hospital records pertaining to specific patients.

The network environment 100 also illustratively includes a plurality of databases, defining secondary caregiver databases, PCGDBᵢ, i=1, . . . , M, (collectively 106). The databases SCGDBᵢ, I=1, . . . , N, include databases maintained, for example, by medical laboratories, medical imaging facilities, and other diagnostic or treatment facilities that support a primary caregiver such as a physician. Each secondary caregiver database SCGDBᵢ comprises a set of data D′, i=1, . . . , M, such as a laboratory test results, images (e.g., x-rays and MRIs), treatment records and programs maintained by therapists, and lists of medications maintained by pharmacies for specific patients.

The network environment 100 also illustratively includes one or more databases 108, defining insurance one or more databases IDB, maintained by various patient insurers. The network environment 100 further illustratively includes a plurality of patient sites II 0 (only one of which is shown). Within the network environment 100, each of the databases 104, 106, 108 as well as the patient site 110 are communicatively linked to the system 102 through a data communications network 112 that can include one or more intermediate nodes (not shown), such as a local area network (LAN), wide area network (WAN), or a plurality of interconnected networks such as the Internet.

Illustratively, the network environment 110 also includes a Universal Health Records (UHRs) database 114 communicatively linked directly to the system 102. The UHRs database 114, alternatively, can be remotely located from the system 102, in which case the UHRs database can be communicatively linked to the system 102 through one or more networks. Conversely, in other embodiments, one or more of the other databases 104, 106, 108 and the patient site 110 can be communicatively linked to the system 102.

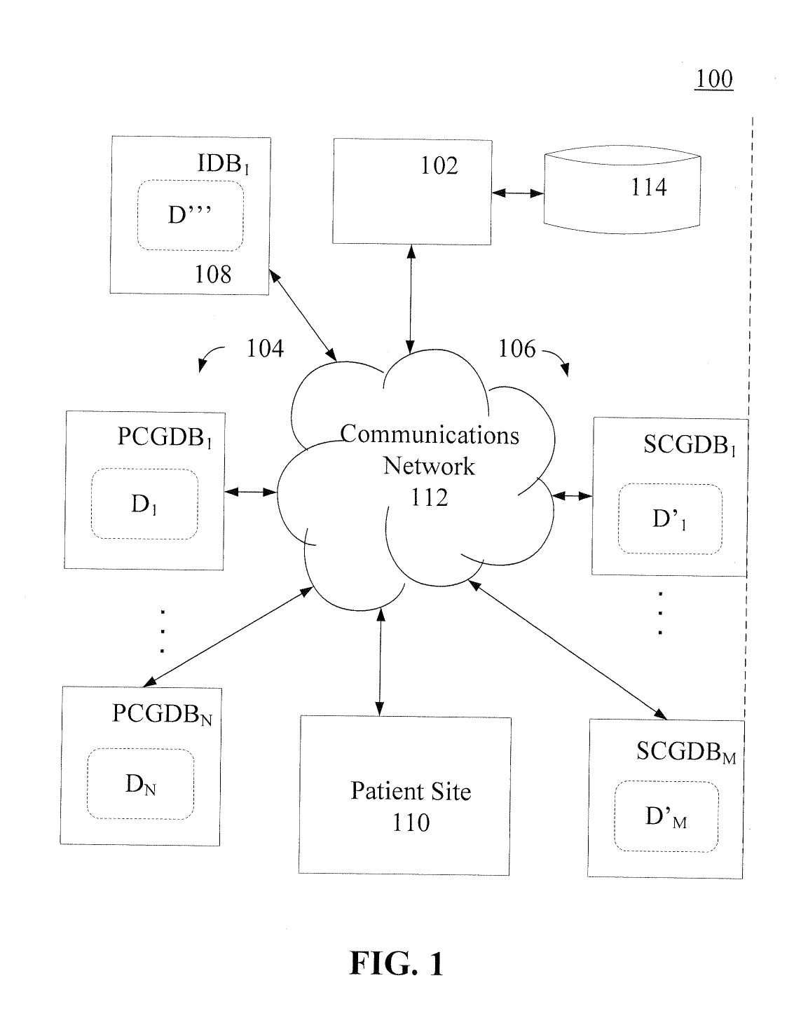

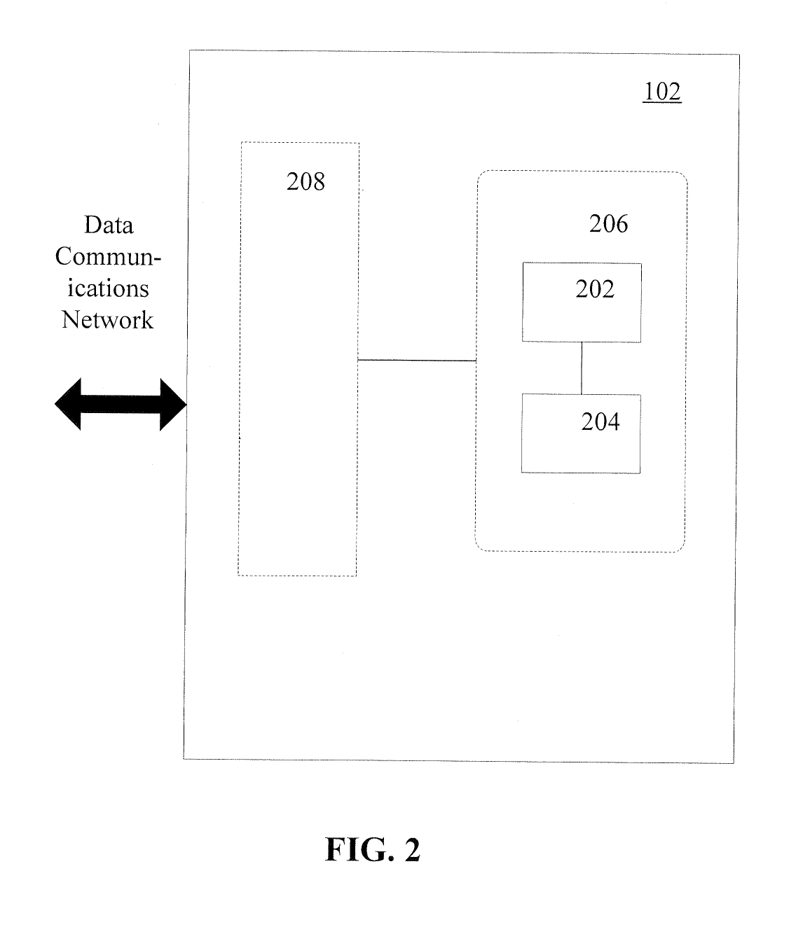

Referring additionally to FIG. 2, a more detailed schematic view is provided of the system 102 shown in FIG. 1. The system 102 illustratively comprises a search engine 202 and a system administrator 204. Preferably, the search engine 202 and system administrator 204 are implemented in computer-readable code that when loaded on a computer or computer-based system cause the computer or computer-based system to perform the procedures and functions described herein. Accordingly, the system 102 optionally can include one or more processors 206 comprising registers, logic gates, and other logic-based circuitry (not shown) for executing the computer-readable code that implements the search engine 202 and system administrator 204.

Alternatively, however, the search engine 202 and system administrator 204 can be implemented in dedicated hardwired circuitry configured to perform the same procedures and functions. In other embodiments, moreover, the search engine 202 and system administrator 204 can be implemented in a combination of computer-readable code and hardwired circuitry.

The system 102 also can optionally include a network interface 208. The network interface 208 can be configured to exchange data between the system and various databases 104, 106, 108 over the data communications network 112.

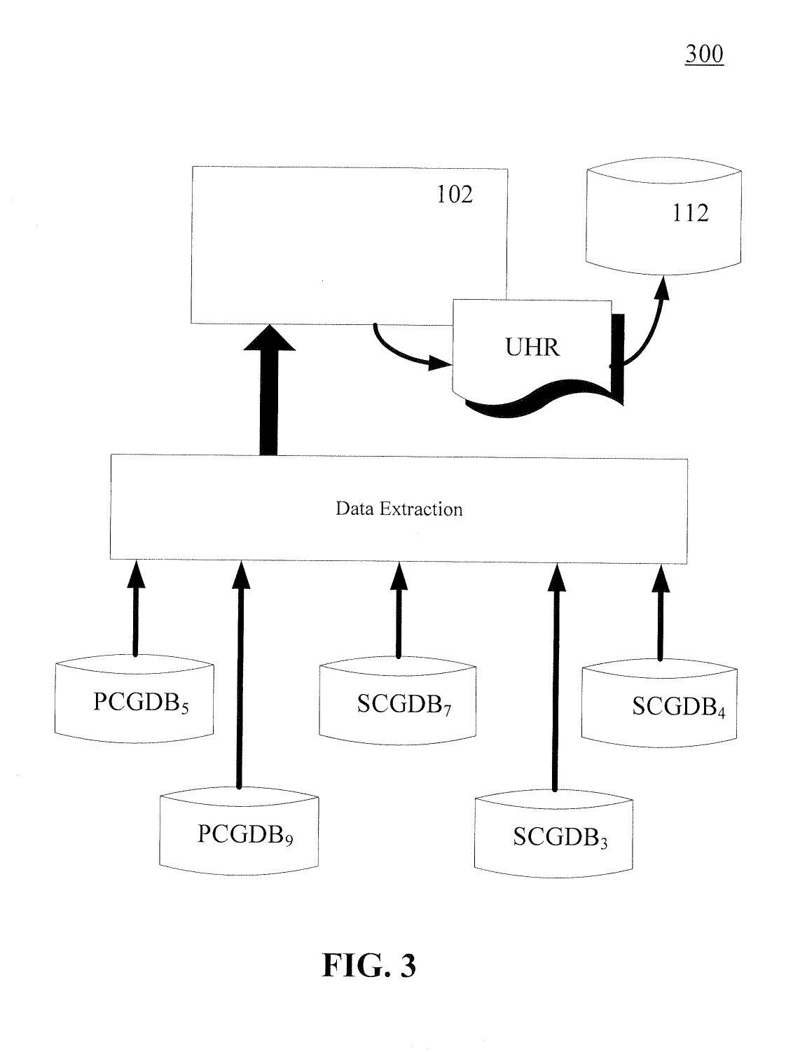

With reference also now to FIG. 3, certain operative features of the system 102 are schematically illustrated. The search engine 202 is configured to identify and retrieve patient specific data from one or more of the databases 104, 106, 108. The system administrator 204 coordinates a plurality of database searches preformed by the search engine 202, and, based thereon, generates a unique, patient-specific UHR for each patient served by the system. The UHR thus comprises or is based upon data retrieved by the search engine.

The system 102 is thus, according to a particular embodiment, able to perform automatic and real-time extractions of data from a variety of sources of information. These sources of patient information can include a patient's own notes or other patient-supplied data, a physician notes or other physician-supplied data, as well as data such as x-ray and MRI images, therapists' notes and data, medication suppliers' data and recommendations pertaining to the patient, and various other types of patient-specific data.

Operatively, patients and doctors names and/or unique identifiers such as identification numbers (e.g., Social Security Numbers and Medical IDs) can be stored in a set of electronic records making up a patient library and physician library, respectively. The names and/or other identifiers can be combined and integrated into a unique UHR for the particular patient. Accordingly, the system 102 also can include at least one patient library and at least one healthcare-provider library, each library comprising at least one identifier used by the system administrator 204 for combining, within the UHR, patient data from the patient library and healthcare data from the healthcare-provider library.

HIPAA-compliant privacy and security management technologies can be applied by the system 102. These technologies can provide those physicians and other healthcare professionals having specific authorization or access-rights access to a patient's UHR. Access can be provided through one or more portals (not shown) of the system 102.

The system 102 can further comprise a protocols engine for defining at least one among formats, data types, synchronization, schedules, and parameters used in generating the UHR. Based on these aormats, data types, synchronization, schedules, and/or parameters, the search engine 202 can perform complex and extensive electronic searches of public and private databases for patient-specific information. The search, nevertheless, can be conditioned on compliance with pre-established privacy, security and protocol settings that permit access to the different databases. Accordingly, the search engine 202 can be configured to perform database searches according to at least one among a pre-established security governance, a pre-established privacy governance, and predetermined protocol settings so as to access one or more secure databases.

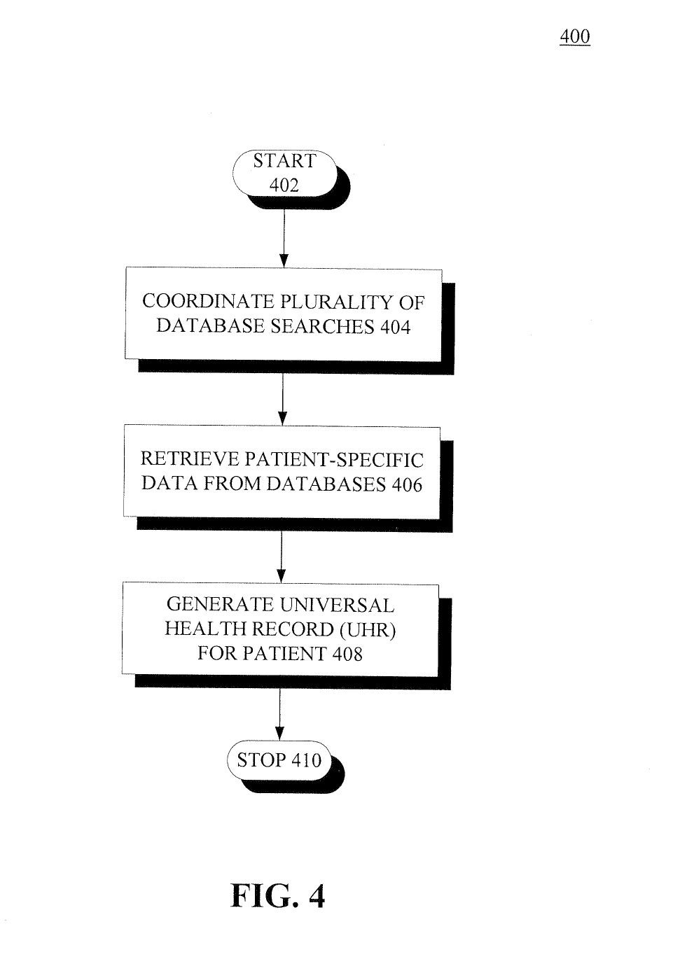

FIG. 4 illustrates certain method aspects of the invention. FIG. 4 is a flowchart of exemplary steps in a method 400 for processing patient information, according another embodiment of the invention.

The method includes, after the start at step 402, coordinating a plurality of database searches of two or more databases for data corresponding to a particular patient at step 404. The method 400 further includes retrieving from one or more of the databases data that corresponds to the patient at step 406. The method 400, at step 408, includes generating a patient-specific UHR comprising the retrieved data. More particularly, generating the UHR at step 408 can, in one embodiment, comprise automatically populating one or more fields of the UHR with at least a portion of the retrieved data.

Once a patient is enrolled in the system through the creation of a UHR for that patient, the UHR can be subsequently updated. Updating can occur continuously, at predetermined intervals, or even randomly. The UHR for the patient can be updated by subsequently repeating the coordinating, retrieving, and generating steps.

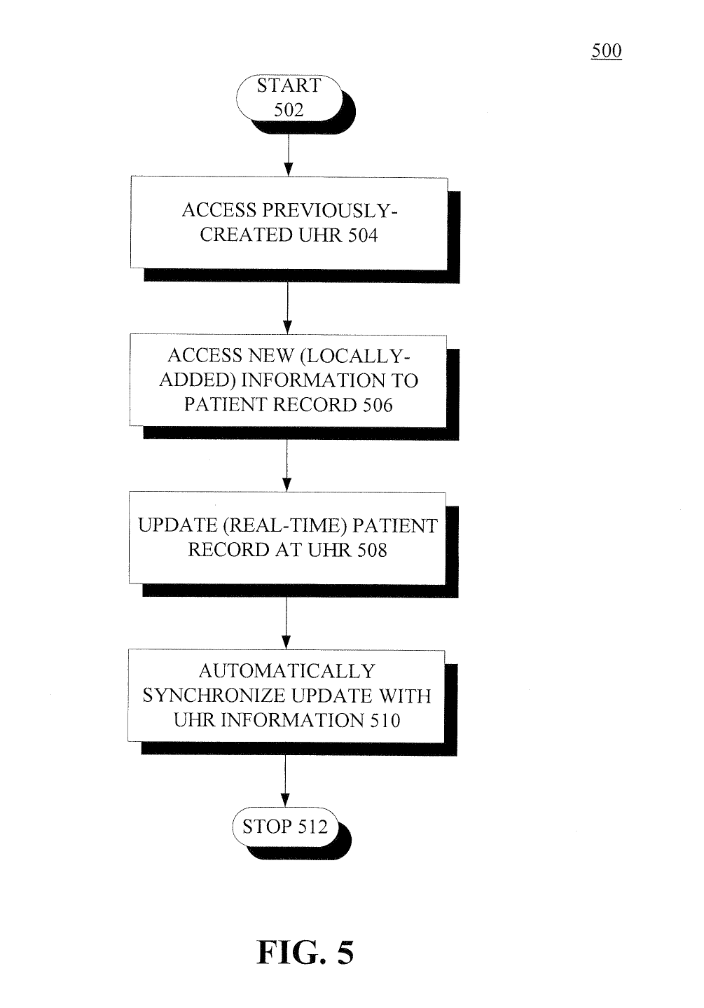

FIG. 5 is a flowchart of exemplary steps in a method 500 of updating an existing UHR. The method 500 includes, after the start at step 502, accessing a previously-created UHR at step 504 and accessing new information that has been locally added to a particular patient record at step 506. At step 508 a real-time updating of the corresponding patient record at the UHR is recorded, and at step 510, the new information is automatically synchronized with related UHR information. The method illustratively concludes at step 512.

The previously-created UHR for the patient can contain a total integration of information obtained from various sources. When a patient record is changed, as for example after a patient visits a physician or other healthcare provider, the UHR can be updated accordingly. Searches can be performed of various databases, as already described. It can be determined whether a value of a particular data element in one or more of these databases has changed during a time interval between a prior search and a subsequent search of the one or more databases. If the value of the particular data element has changed, the updating step can be performed by substituting the changed value for a corresponding value contained in a field of the UHR.

Another embodiment of the invention is a method for enrolling a new patient. If it is determined that a patient is a newly-enrolled patient, a patient profile is generated for the patient. The patient profile can comprise at least one among an identification number, a privacy governance, and a security governance. The method can further comprise generating a corresponding template if the patient is newly enrolled, the template comprising sections of the UHR to be completed. The method thus can further comprise creating at least one of a privacy restriction corresponding to the privacy governance and a security restriction corresponding to the security governance. Additionally, the method can include completing the sections of the UHR by performing the coordinating, retrieving, and generating steps described above. This also can include validating and/or time stamping data retrieved during the process. The process of enrolling a new patient can be integrated with the above-described processes.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method for processing patient information, the method comprising:
coordinating a plurality of database searches of two or more databases for data corresponding to a particular patient;
retrieving from one or more of the databases data corresponding to the patient; and
generating a patient-specific uniform health record (UHR) comprising the retrieved data.

2. The method of claim 1, wherein the generating step comprises automatically populating one or more fields of the UHR with at least a portion of the retrieved data.

3. The method of claim 1, further comprising updating the UHR by subsequently repeating the coordinating, retrieving, and generating steps.

4. The method of claim 3, wherein the updating step comprises determining whether a value of a particular data element of data in one or more of the databases has changed during a time interval between a prior search and a subsequent search of the one or more databases.

5. The method of claim 4, wherein, if the value of the particular data element has changed, the updating step further comprises substituting the changed value for a corresponding value contained in a field of the UHR.

6. The method of claim 1, further comprising determining whether the patient is a newly-enrolled patient, and, if the patient is newly enrolled, generating a patient profile for the patient, the patient profile comprising at least one among an identification number, a privacy governance, and a security governance.

7. The method of claim 6, further comprising generating a corresponding template if the patient is newly enrolled, the template comprising sections of the UHR to be completed.

8. The method of claim 7, further comprising creating at least one of a privacy restriction corresponding to the privacy governance and a security restriction corresponding to the security governance.

9. The method of claim 8, further comprising completing the sections of the UHR by performing the coordinating, retrieving, and generating steps.

10. The method of claim 9, wherein the completing step comprises at least one of validating and time stamping data retrieved.

11. A system for processing patient information, the system comprising: a search engine for identifying and retrieving patient-specific data from one or more of the databases; and
a system administrator for coordinating a plurality of database searches preformed by the search engine and for generating a patient-specific uniform health record (UHR) comprising data retrieved by the search engine.

12. The system of claim 11, further comprising at least one patient library and at least one healthcare provider library, each library comprising at least one identifier used by the system administrator for combining patient data from the patient library and healthcare data from the healthcare provider library in the UHR.

13. The system of claim 11, further comprising a protocols engine for defining at least one among formats, data types, synchronization, schedules, and parameters used in generating the UHR.

14. The system of claim 11, wherein the search engine is configured to perform database searches according to at least one among a pre-established security governance, a pre-established privacy governance, and predetermined protocol settings so as to access one or more secure databases.

15. A computer-readable medium in which is embedded computer-readable code that when loaded on a computer causes the computer to perform the steps of:
coordinating a plurality of database searches of two or more databases for data corresponding to a particular patient;
retrieving from one or more of the databases data corresponding to the patient; and
generating a patient-specific uniform health record (UHR) comprising the retrieved data.

16. The computer-readable medium of claim 15, wherein the generating step comprises automatically populating one or more fields of the UHR with at least a portion of the retrieved data.

17. The computer-readable medium of claim 15, further computer-readable code for causing the computer to perform the step of updating the UHR by subsequently repeating the coordinating, retrieving, and generating steps.

18. The computer-readable medium of claim 17, wherein the updating step comprises determining whether a value of a particular data element of data in one or more of the databases has changed during a time interval between a prior search and a subsequent search of the one or more databases.

19. The computer-readable medium of claim 18, wherein, if the value of the particular data element has changed, the updating step further comprises substituting the changed value for a corresponding value contained in a field of the UHR.

20. The computer-readable medium of claim 15, further comprising computer-readable code for causing the computer to perform the step of determining whether the patient is a newly-enrolled patient, and, if the patient is newly enrolled, generating a patient profile for the patient, the patient profile comprising at least one among an identification number, a privacy governance, and a security governance.
